(19) United States
(12) Patent Application Publication
(10) Pub. No.: US 2025/0317522 A1
(43) Pub. Date: Oct. 9, 2025

(54) READING APPARATUS

(71) Applicant: SEIKO EPSON CORPORATION, Tokyo (JP)

(72) Inventor: Keita FUJI, MATSUMOTO-SHI (JP)

(21) Appl. No.: 19/172,182

(22) Filed: Apr. 7, 2025

(30) Foreign Application Priority Data
Apr. 8, 2024 (JP) 2024-062192

(51) Int. Cl. H04N 1/00; B65H 1/04

(52) U.S. Cl. CPC H04N 1/00554; B65H 1/04; B65H 2402/442; H04N 2201/0094

(57) ABSTRACT

A reading apparatus includes a main body section in which a reading section for a document is provided and a cover section capable of opening and closing by turning with respect to the main body section, a first surface of the cover section forming an upper surface in a closed state and a second surface of the cover section forming a support surface that supports the document in an open state. The cover section includes an operation section, a turning shaft, and a lock section. A distance from the operation section to the lock section is longer than a distance from the turning shaft to the lock section in an intersecting direction.

The present application is based on, and claims priority from JP Application Serial Number 2024-062192, filed Apr. 8, 2024, the disclosure of which is hereby incorporated by reference herein in its entirety.

### BACKGROUND

### 1. Technical Field

The present disclosure relates to a reading apparatus.

### 2. Related Art

There has been used a reading apparatus including a main body section in which a reading section is provided and a cover section that can be opened and closed by turning with respect to the main body section. For example, JP-A-2016-40191 discloses an image reading apparatus including an ADF unit in which a reading unit is provided and a central cover that can be opened and closed by turning with respect to the ADF unit.

JP-A-2016-40191 is an example of the related art.

In a reading apparatus of the related art including a main body section in which a reading section is provided and a cover section that can be opened and closed by turning with respect to the main body section like the image reading apparatus of JP-A-2016-40191, operability at the time when opening and closing the cover section is sometimes not high. For example, the image reading apparatus of JP-A-2016-40191 includes a lock mechanism including an engaging section and a section to be engaged in order to suppress rattling at the time when the central cover is closed. The lock mechanism is disposed at a position close to a distal end separated from a turning shaft in order to suppress rattling. However, in the case of such a configuration, an operation force at the time of locking in closing the central cover and at the time of unlocking in opening the central cover tends to be large. Therefore, operability is not high.

### SUMMARY

According to an aspect of the present disclosure, there is provided a reading apparatus including: a main body section in which a reading section configured to read a document is provided; a document support section configured to support the document before being fed; a feeding section configured to feed the document supported by the document support section toward the reading section; a cover section opened and closed by turning with respect to the main body section, a first surface of the cover section forming an upper surface in a closed state and a second surface of the cover section opposite to the first surface forming a support surface that supports the document in conjunction with the document support section in an open state; and an upper surface forming section forming an upper surface in conjunction with the cover section, wherein the cover section includes: an operation section serving as a power point in opening and closing; a turning shaft serving as a fulcrum in opening and closing; and a lock section restricted from being opened in a closed state, and a distance from the operation section to the lock section is longer than a distance from the turning shaft to the lock section in an intersecting direction intersecting an axial direction of the turning shaft.

### BRIEF DESCRIPTION OF THE DRAWINGS

FIG. 1 is a perspective view illustrating a state in which a cover section is closed

in a multifunction peripheral including a reading apparatus according to a first embodiment.

FIG. 2 is a perspective view illustrating a state in which a cover section of the reading apparatus of the multifunction peripheral in FIG. 1 is opened.

FIG. 3 is a perspective view from above illustrating the state in which the cover section of the reading apparatus of the multifunction peripheral in FIG. 1 is closed.

FIG. 4 is a cross-sectional view of the reading apparatus of the multifunction peripheral in FIG. 1 viewed from a front side and is a diagram illustrating the state in which the cover section is closed.

FIG. 5 is a cross-sectional view of the reading apparatus of the multifunction peripheral in FIG. 1 viewed from the front side and is a diagram illustrating the state in which the cover section is opened.

FIG. 6 is a diagram of the periphery of the cover section of the reading apparatus of the multifunction peripheral in FIG. 1 viewed from a bottom surface side and is a diagram illustrating the state in which the cover section is closed.

FIG. 7 is a front cross-sectional view of a part of the reading apparatus of the multifunction peripheral in FIG. 1.

FIG. 8 is a front cross-sectional view illustrating a cross section at a position different from a position in FIG. 7 in the reading apparatus of the multifunction peripheral in FIG. 1.

FIG. 9 is a perspective view illustrating the periphery of an arm section of the cover section of the reading apparatus of the multifunction peripheral in FIG. 1.

FIG. 10 is a perspective view of a part of the cover section of the reading apparatus of the multifunction peripheral in FIG. 1.

FIG. 11 is a perspective view of a part of a main body section of the reading apparatus of the multifunction peripheral in FIG. 1, the part being a portion that supports the cover section.

FIG. 12 is a perspective view illustrating a state halfway in closing the cover section of the reading apparatus of the multifunction peripheral in FIG. 1 from the open state.

FIG. 13 is a front view illustrating the position of a lock pin of the cover section of the reading apparatus of the multifunction peripheral in FIG. 1 corresponding to the position of the cover section in FIG. 12.

FIG. 14 is a side view illustrating the position of the lock pin of the cover section of the reading apparatus of the multifunction peripheral in FIG. 1 corresponding to the position of the cover section in FIG. 12.

FIG. 15 is a perspective view illustrating a state halfway in further closing the cover section of the reading apparatus of the multifunction peripheral in FIG. 1 from the position in FIG. 12.

FIG. 16 is a front view illustrating the position of the lock pin of the cover section of the reading apparatus of the multifunction peripheral in FIG. 1 corresponding to the position of the cover section in FIG. 15.

FIG. 17 is a side view illustrating the position of the lock pin of the cover section of the reading apparatus of the multifunction peripheral in FIG. 1 corresponding to the position of the cover section in FIG. 15.

FIG. 18 is a perspective view illustrating the state in which the cover section of the reading apparatus of the multifunction peripheral in FIG. 1 is closed.

FIG. 19 is a front view illustrating the position of the lock pin of the cover section of the reading apparatus of the multifunction peripheral in FIG. 1 corresponding to the position of the cover section in FIG. 18.

FIG. 20 is a side view illustrating the position of the lock pin of the cover section of the reading apparatus of the multifunction peripheral in FIG. 1 corresponding to the position of the cover section in FIG. 18.

FIG. 21 is a plan view illustrating the cover section of the reading apparatus of the multifunction peripheral in FIG. 1.

FIG. 22 is a plan view illustrating a cover section of a reading apparatus in a second embodiment.

### DESCRIPTION OF EMBODIMENTS

The present disclosure is schematically explained below.

According to a first aspect of the present disclosure, there is provided a reading apparatus including: a main body section in which a reading section configured to read a document is provided; a document support section configured to support the document before being fed; a feeding section configured to feed the document supported by the document support section toward the reading section; a cover section capable of opening and closing by turning with respect to the main body section, a first surface of the cover section forming an upper surface in a closed state and a second surface of the cover section opposite to the first surface forming a support surface that supports the document in conjunction with the document support section in an open state; and an upper surface forming section forming an upper surface in conjunction with the cover section, wherein the cover section includes: an operation section serving as a power point in opening and closing; a turning shaft serving as a fulcrum in opening and closing; and a lock section restricted from being opened in the closed state, and a distance from the operation section to the lock section is longer than a distance from the turning shaft to the lock section in an intersecting direction intersecting an axial direction of the turning shaft.

According to this aspect, the cover section includes the operation section serving as the power point in opening and closing, the turning shaft serving as the fulcrum in opening and closing, and the lock section restricted from being opened in the closed state. In the intersecting direction intersecting the axial direction of the turning shaft, the distance from the operation section to the lock section is longer than the distance from the turning shaft to the lock section. With such a configuration, it is possible to weaken an operation force at the time of locking in closing the cover section and at the time of unlocking in opening the cover section and it is possible to improve operability in opening and closing the cover section.

A second aspect is an aspect dependent from the first aspect, wherein the lock section is urged in a direction in which the cover section is closed.

According to this aspect, the lock section is urged in the direction in which the cover section is closed. With such a configuration, it is possible to prevent the cover section from rattling when the cover section is in the closed state.

A third aspect is an aspect dependent from the first or second aspect, wherein the operation section is provided at an end portion on one side in the axial direction of the cover section.

According to this aspect, the operation section is provided at the end portion on one side in the axial direction of the cover section. That is, it is possible to provide the operation section at a position where the cover section can be easily operated such as the front surface side of the cover section viewed from a user. Therefore, it is possible to particularly improve the operability in opening and closing the cover section.

A fourth aspect is an aspect dependent from any one of the first to third aspects, wherein the lock section is provided at an end portion on one side in the axial direction of the cover section.

According to this aspect, the lock section is provided at the end portion on one side in the axial direction of the cover section. That is, it is possible to provide the lock section on the front surface side of the cover section viewed from the user. Therefore, locking is easily performed by closing the cover section and it is possible to particularly improve the operability.

A fifth aspect is an aspect dependent from any one of the first to fourth aspects, wherein the operation section and the lock section are provided at an end portion on one side in the axial direction of the cover section, the operation section includes a grip section, and the grip section is located further on another side in the axial direction than the lock section.

According to this aspect, the operation section and the lock section are provided at the end portion on one side in the axial direction of the cover section and the grip section of the operation section is located further on the other side in the axial direction than the lock section. With such a configuration, a position close to the center in the axial direction is the power point and it is possible to particularly improve operability in opening and closing the cover section.

A sixth aspect is an aspect dependent from any one of the first to fifth aspects, wherein the operation section and the lock section are provided at an end portion on one side in the axial direction of the cover section, the operation section includes a grip section, and the grip section is provided at a position including a center in the intersecting direction of the cover section.

According to this aspect, the operation section and the lock section are provided at the end portion on one side in the axial direction of the cover section and the grip section of the operation section is provided at the position including the center in the intersecting direction of the cover section. With such a configuration, the user can easily access the grip section and it is possible to particularly improve operability in opening and closing the cover section.

A seventh aspect is an aspect dependent from any one of the first to sixth aspects, wherein the lock section includes a projection, the main body section includes a section to be engaged with which the projection engages when the cover section is in the closed state, and, in the projection, an engagement region that engages with the section to be engaged is chamfered.

According to this aspect, the engagement region of the projection that engages with the section to be engaged is chamfered. With such a configuration, the projection serving as an engaging section and the section to be engaged are easily engaged with each other and it is possible to particularly improve operability in closing and locking the cover section.

An eighth aspect is an aspect dependent from any one of the first to seventh aspects, wherein the cover section includes a rib extended in the axial direction.

According to this aspect, the cover section includes the rib extended in the axial direction. With such a configuration, it is possible to reinforce the cover section.

A ninth aspect is an aspect dependent from any one of the first to eighth aspects, further including a buffer member that comes into contact with the cover section when the cover section is in the closed state.

According to this aspect, the buffer member that comes into contact the cover section when the cover section is in the closed state is provided. With such a configuration, it is possible to suppress sound at the time when the cover section is closed and damage involved in closing the cover section.

A tenth aspect is an aspect dependent from any one of the first to ninth aspects, wherein the cover section includes an arm section, the upper surface forming section includes a contact section at a position facing a distal end of the arm section when the cover section is in the closed state, and the contact section includes a rib extended in the intersecting direction.

According to this aspect, the cover section includes the arm section, the upper surface forming section includes the contact section at the position facing the distal end of the arm section when the cover section is in the closed state, and the contact section includes the rib extended in the intersecting direction. With such a configuration, it is possible to reinforce the contact section.

### First Embodiment

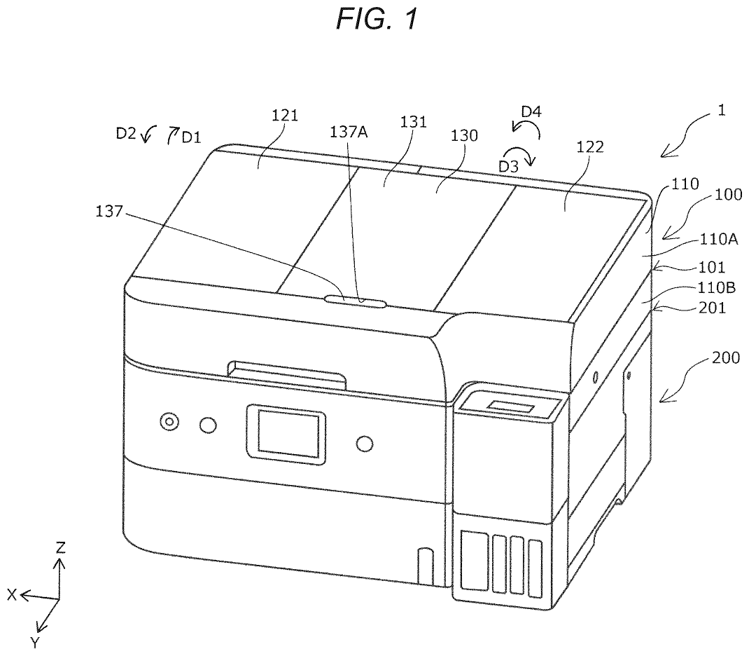

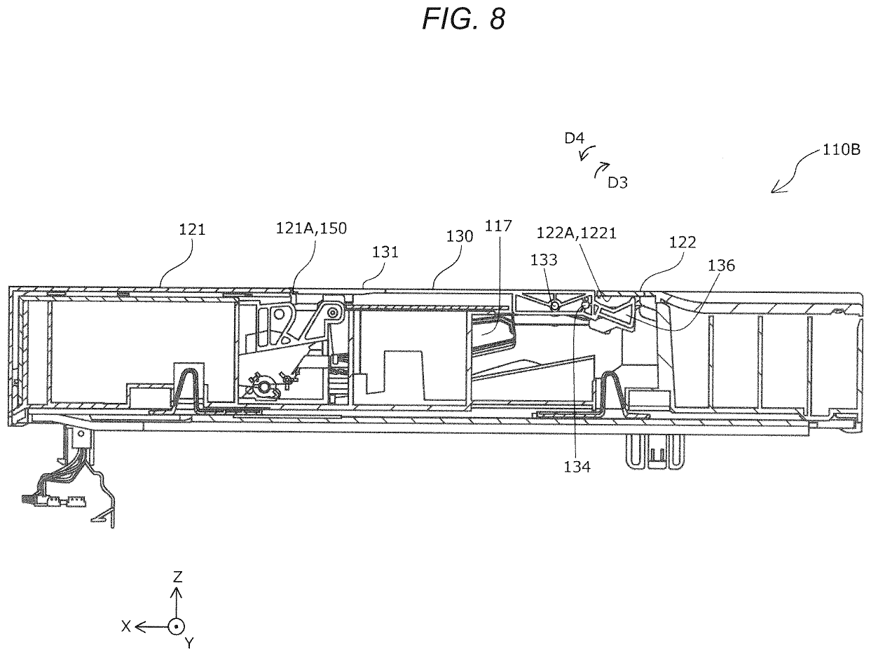

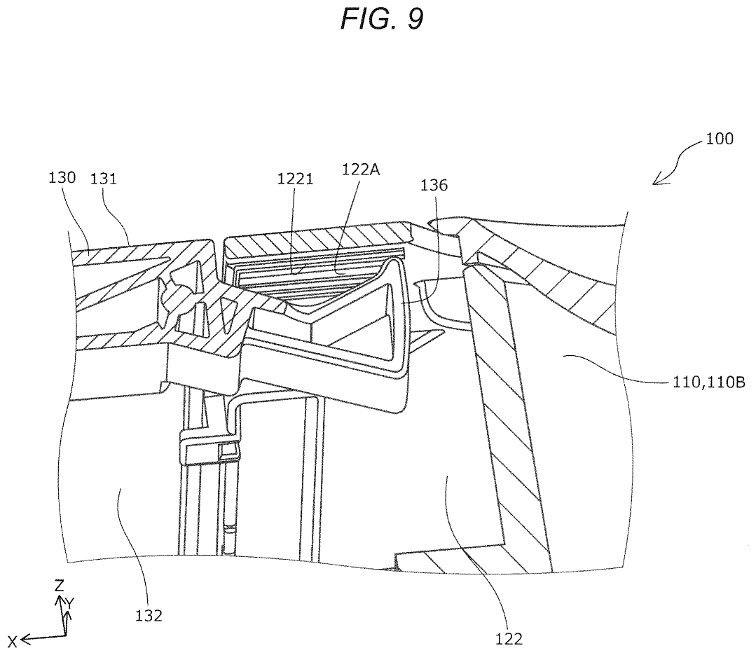

An embodiment is explained below with reference to the drawings. First, a reading apparatus 100 in a first embodiment is explained with reference to FIGS. 1 to 21. The same components in embodiments are denoted by the same reference numerals and signs and are explained only in the first embodiment and explanation of the components is omitted in the following embodiments.

In the following explanation, as an example of the reading apparatus 100, a multifunction peripheral 1 is configured in conjunction with a recording apparatus 200 that is an inkjet printer. However, without being limited to such a configuration, a reading apparatus may be configured alone or a multifunction peripheral may be configured in conjunction with a recording apparatus other than the inkjet printer, a recording apparatus of an electrophotographic scheme, a dot impact scheme, or the like.

In an X-Y-Z coordinate system illustrated in the figures, an X direction indicates an apparatus width direction, a Y direction indicates an apparatus depth direction, and a Z direction indicates an apparatus height direction and the vertical direction. A +Y direction is a direction from an apparatus rear surface to an apparatus front surface and a −Y direction is a direction from the apparatus front surface to the apparatus rear surface. The apparatus front surface is a surface facing an operator in the apparatus. Which side surface among side surfaces of the apparatus is the apparatus front surface is determined based on an apparatus configuration and exterior design.

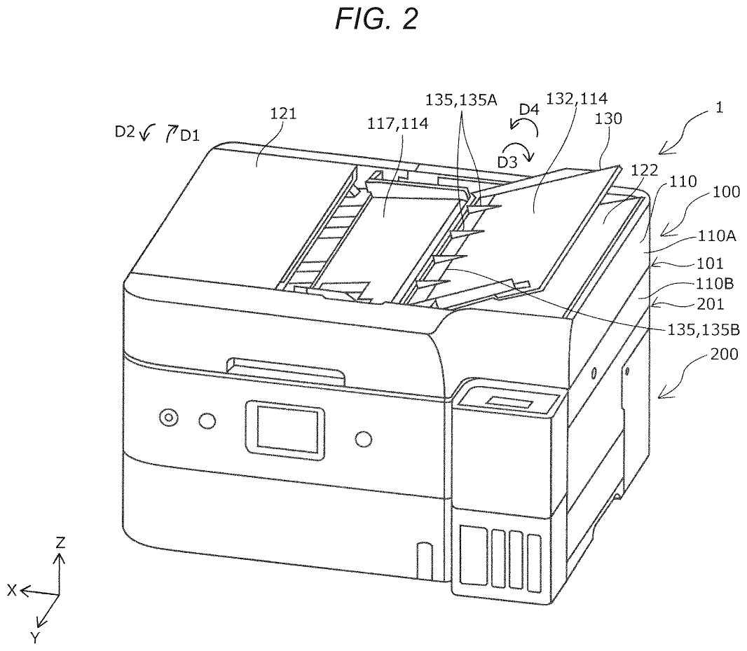

In the multifunction peripheral 1, the reading apparatus 100 is coupled to the recording apparatus 200 to be capable of turning with respect to the recording apparatus 200 based on a turning shaft 201 in directions represented by turning directions D1 and D2 in FIGS. 1 and 2. The turning shaft 201 is provided at a −Y direction side end portion. The turning shaft 201 extends in the X direction. For example, by rotating the reading apparatus 100 in the rotation direction D1 with respect to the recording apparatus 200 from the state illustrated in FIG. 1, the user can access a not-illustrated inkjet head provided in the recording apparatus 200.

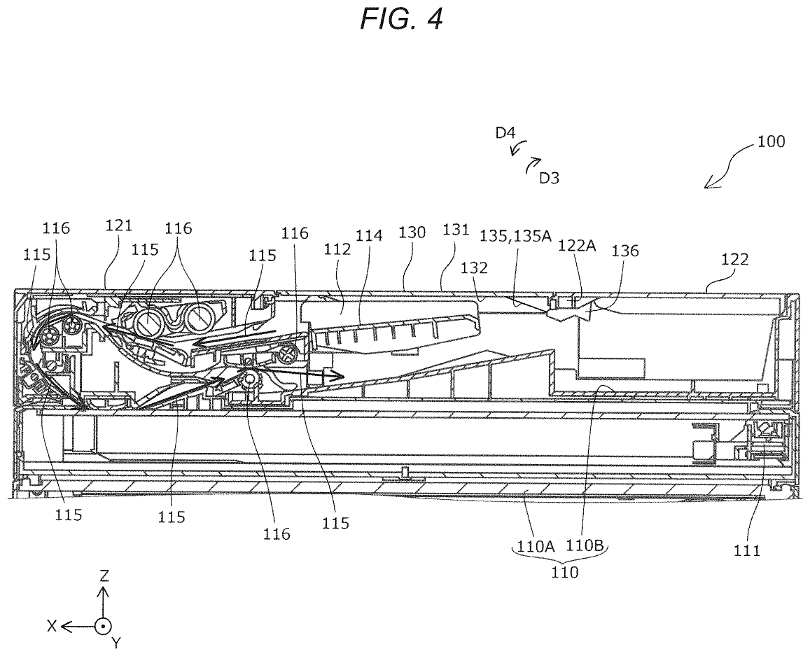

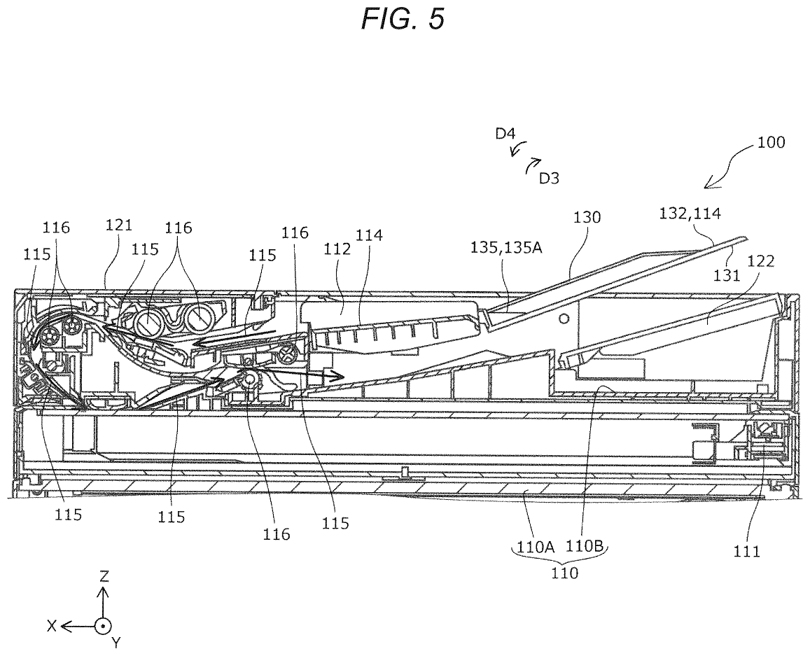

As illustrated in FIGS. 4 and 5, the reading apparatus 100 includes a main body section 110 in which a reading section 111 that reads a document is provided. The main body section 110 includes a scanner main body 110A in which the reading section 111 is provided and an auto document feeder 110B. The auto document feeder 110B is coupled to the scanner main body 110A to be capable of turning with respect to the scanner main body 110A based on the turning shaft 101 in the directions represented by the turning directions D1 and D2 in FIGS. 1 and 2. The turning shaft 101 is provided at a −Y direction side end portion. The turning shaft 101 extends in the X direction. The user can open the automatic document feeder 110B with respect to the scanner main body 110A and set a document on the scanner main body 110A. By closing the automatic document feeder 110B with respect to the scanner main body 110A, the user can read the document set on the scanner main body 110A.

As illustrated in FIGS. 1 to 5, the reading apparatus 100 includes a cover section 130 and a discharge tray 122 that form an upper surface in conjunction with a base frame 121. The cover section 130 and the discharge tray 122 are configured to be capable of switching a non-feeding state illustrated in FIGS. 1 and 4 and a feeding state illustrated in FIGS. 2 and 5.

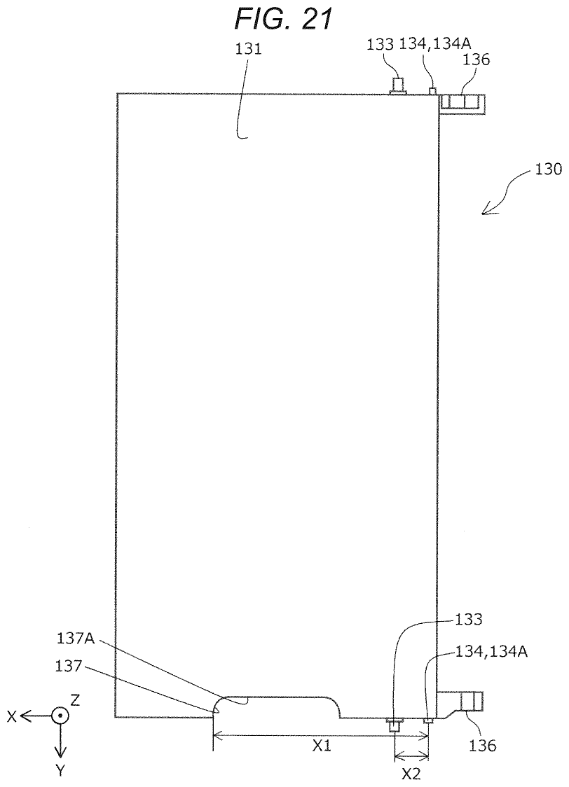

Specifically, the cover section 130 includes a turning shaft 133 illustrated in FIG. 21 and the like. The turning shaft 133 extends in the Y direction. As it is seen when FIG. 1 and FIG. 2 and FIG. 4 and FIG. 5 are compared, the cover section 130 can be opened and closed with respect to the main body section 110 by turning in turning directions D3 and D4. As illustrated in FIGS. 1, 3, and 4, in the cover section 130, a first surface 131 forms the upper surface in the non-feeding state which is the closed state. As illustrated in FIGS. 2 and 5, in the cover section 130, a second surface 132 on a side opposite to the first surface 131 forms a support surface 114 capable of supporting a document in the feeding state that is an open state. The discharge tray 122 is in a substantially horizontal state like the base frame 121 in the non-feeding state and is in a state of being inclined with respect to the horizontal direction like the cover section 130 in the feeding state. That is, the base frame 121 and the discharge tray 122 correspond to an upper surface forming section that forms the upper surface of the reading apparatus 100 in conjunction with the cover section 130.

As illustrated in FIGS. 2, 4, and 5, the reading apparatus 100 includes a document support section 117 capable of supporting a document before being fed. The document support section 117 forms the support surface 114 in conjunction with the second surface 132 of the cover section 130 in the open state.

The document supported by the document support section 117 and the second surface 132 of the cover section 130 is fed to a document conveyance path 115. As illustrated in FIGS. 4 and 5, in the document conveyance path 115, the reading section 111 and a plurality of conveying rollers 116 are provided. The reading section 111 is movable in the X direction and, when reading a document set on the support surface 114, moves to a predetermined reading position and reads an image of the conveyed document at the reading position. That is, the document supported by the document support section 117 and the second surface 132 of the cover section 130 is conveyed on the document conveyance path 115 by the plurality of conveying rollers 116. The image of the document conveyed on the document conveyance path 115 is read by the reading section 111 on the scanner main body 110A, and the document is discharged to the discharge tray 122. The plurality of conveying rollers 116 play a role of a feeding section that feeds the document supported by the document support section 117 toward the reading section 111.

In the following explanation, details of the cover section 130, which is a main part of the reading apparatus 100 in the present embodiment, is explained. In particular, a configuration of a lock section 134 that maintains the state in which the cover section 130 is closed with respect to the main body section when the cover section 130 is closed with respect to the main body section as illustrated in FIGS. 1 and 4 and the like is explained in detail.

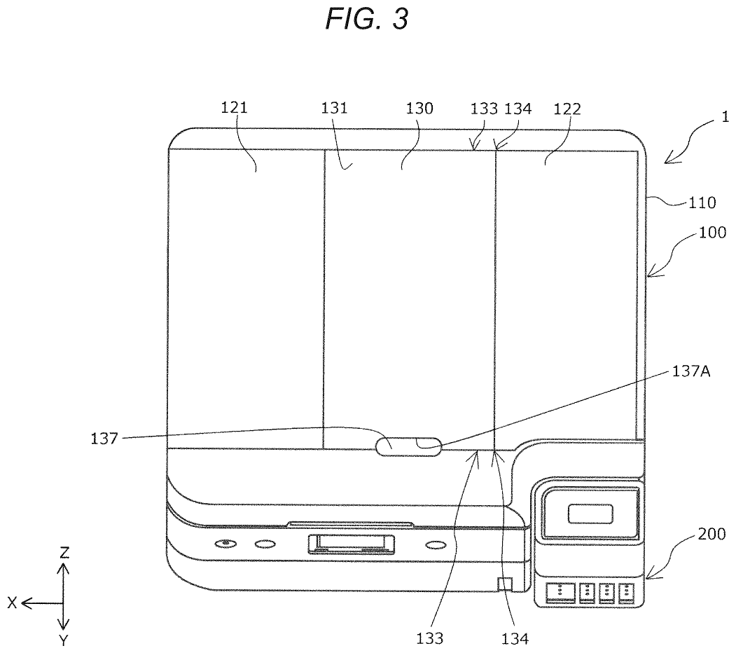

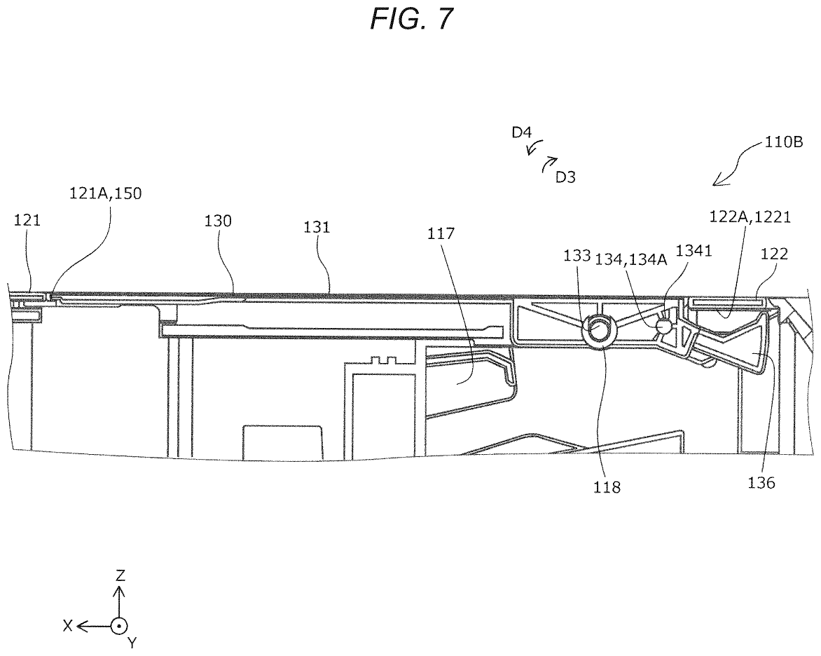

As illustrated in FIGS. 3 and 21 and the like, the cover section 130 includes an operation section 137 including a grip section 137A, which can be gripped by the user, and serving as a power point at the time when the cover section 130 is opened and closed with respect to the main body section 110. As illustrated in FIGS. 7 and 21 and the like, the cover section 130 includes the turning shaft 133 serving as a fulcrum at the time when the cover section 130 is opened and closed with respect to the main body section 110. Further, as illustrated in FIGS. 7 and 21 and the like, the cover section 130 includes the lock section 134 restricted from being opened when the cover section 130 is in the state of being closed with respect to the main body section 110.

Here, the lock section 134 is provided near the turning shaft 133. In other words, as illustrated in FIG. 21, in the X direction, a distance X1 from the operation section 137 to the lock section 134 is longer than a distance X2 from the turning shaft 133 to the lock section 134. The X direction is an intersecting direction intersecting the Y direction that is the axial direction of the turning shaft 133. Here, the distance X1 from the operation section 137 to the lock section 134 can be set to a maximum distance from the center of the lock section 134 in the X direction to the operation section 137 in the X direction. The distance X1 from the operation section 137 to the lock section 134 may be set to the distance from the center of the lock section 134 in the X direction to the center of the operation section 137 in the X direction. On the other hand, the distance X2 from the turning shaft 133 to the lock section 134 can be set to the distance from the center of the lock section 134 in the X direction to the center of the turning shaft 133 in the X direction.

With such a configuration, the reading apparatus 100 can weaken an operation force at the time of locking when the cover section 130 is closed and at the time of unlocking when the cover section 130 is opened. Accordingly, it is possible to improve operability of the user in opening and closing the cover section 130. Since the reading apparatus 100 in the present embodiment includes the lock section 134, it is also possible to suppress rattling of the cover section 130 with respect to the main body section 110 at the time when the cover section 130 is closed.

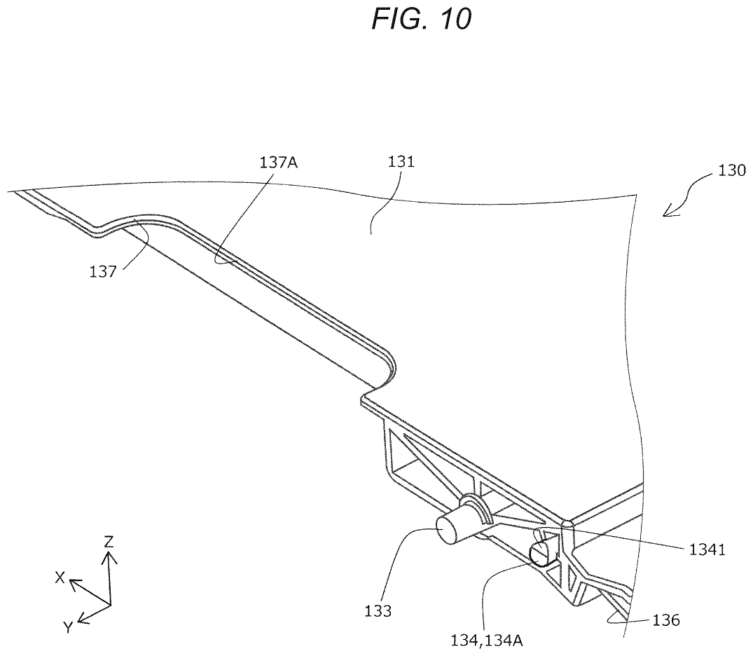

Details of the configuration of the lock section 134 are further explained below. As illustrated in FIG. 10 and the like, the cover section 130 includes the turning shaft 133, the lock section 134, and an arm section 136 on the end portion side in the −X direction. As illustrated in FIGS. 3 and 21 and the like, a position in the X direction of the operation section 137 is substantially the center of the cover section 130.

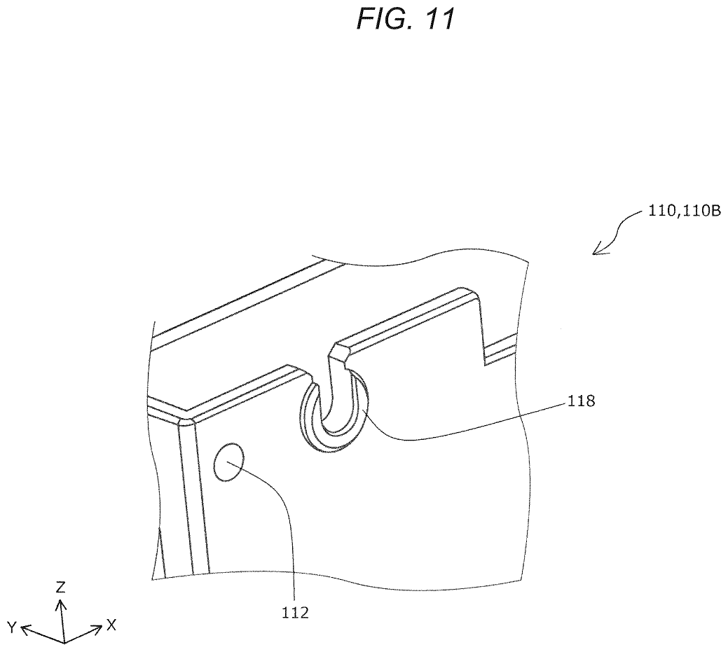

On the other hand, as illustrated in FIG. 11 and the like, in the main body section 110, a bearing 118 that receives the turning shaft 133 and a hemispherical section to be engaged 112 with which the lock section 134 can engage are provided. Here, the section to be engaged 112 is located at a position where the section to be engaged 112 does not come into contact with the lock section 134 when the cover section 130 is in the open state with respect to the main body section 110 and comes into contact with the lock section 134 when the cover section 130 is in the closed state with respect to the main body section 110.

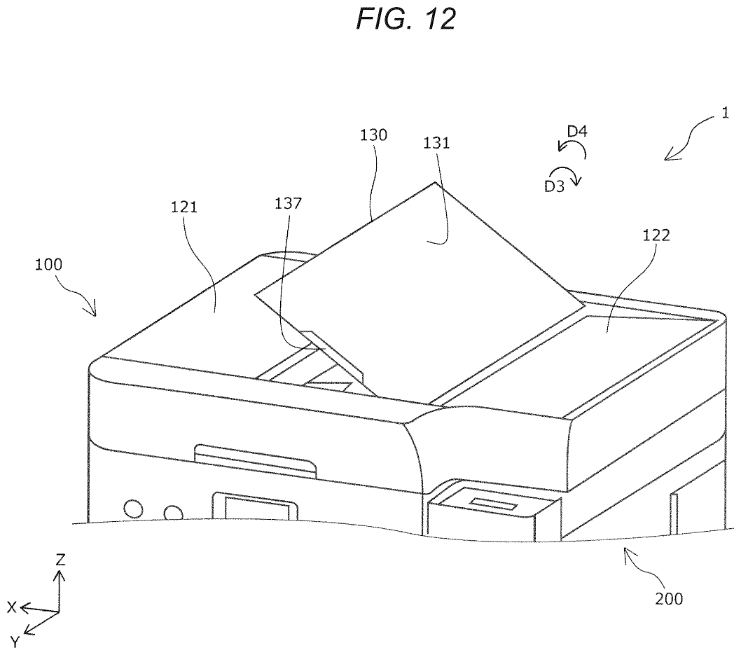

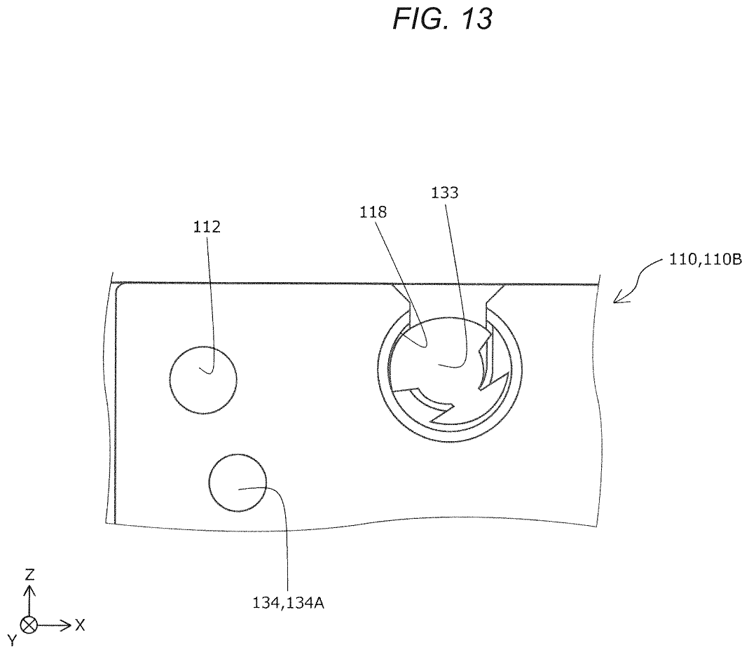

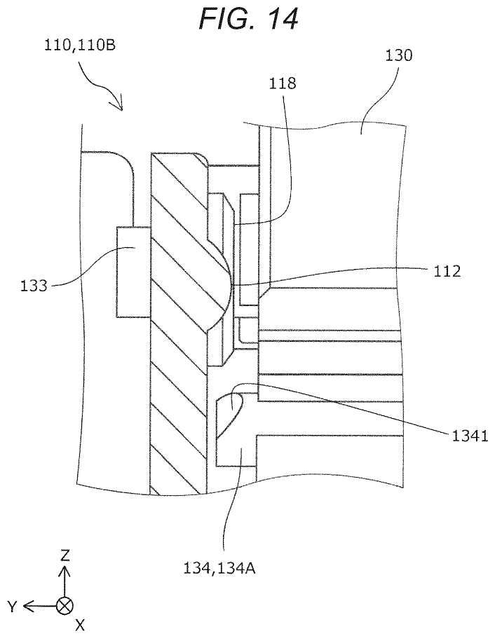

In the following explanation, a positional relationship between the lock section 134 and the section to be engaged 112 from when the cover section 130 is in the open state with respect to the main body section 110 to when the cover section 130 is closed is explained. The lock section 134 and the section to be engaged 112 do not come into contact with each other from when the cover section 130 illustrated in FIG. 1 is in a state of being opened to the maximum with respect to the main body section 110 until when the cover section 130 is opened to some extent as illustrated in FIG. 12. FIGS. 13 and 14 illustrate a positional relationship between the lock section 134 and the section to be engaged 112 in the state illustrated in FIG. 12 and indicate that the lock section 134 and the section to be engaged 112 are present at positions separated from each other.

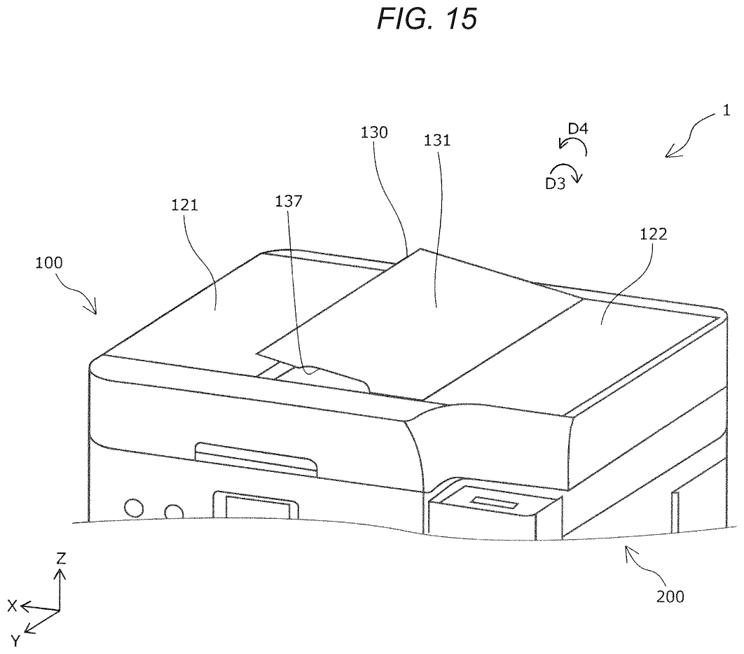

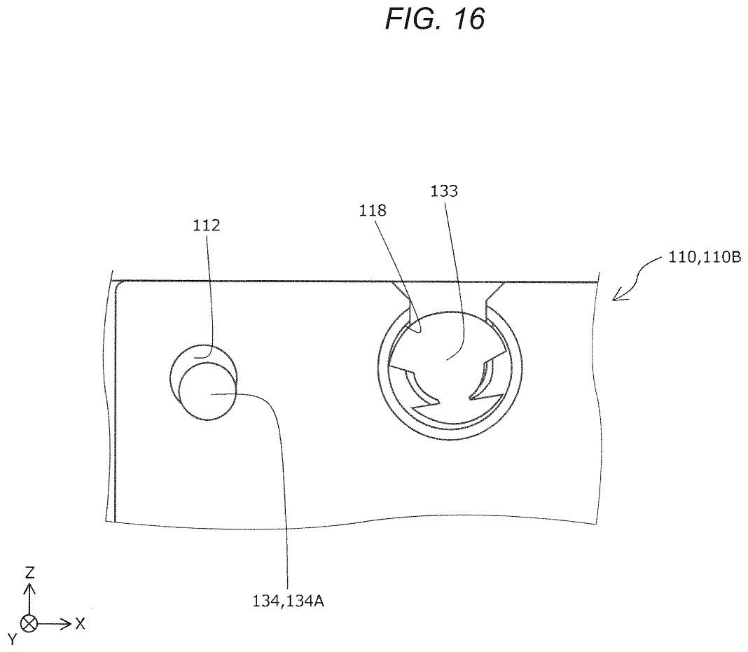

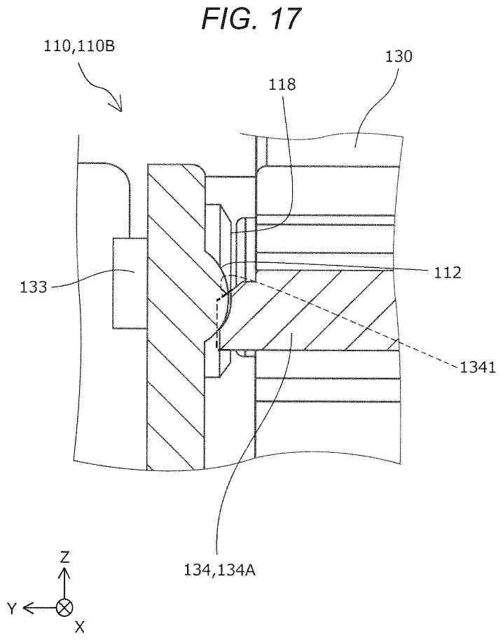

When the cover section 130 is further closed with respect to the main body section 110 from the state illustrated in FIG. 12 to the state illustrated in FIG. 15, the lock section 134 and the section to be engaged 112 start to come into contact with each other. FIGS. 16 and 17 illustrate a positional relationship between the lock section 134 and the section to be engaged 112 in the state illustrated in FIG. 15 and indicate that the lock section 134 is a state of being in contact with the section to be engaged 112 from the downward direction.

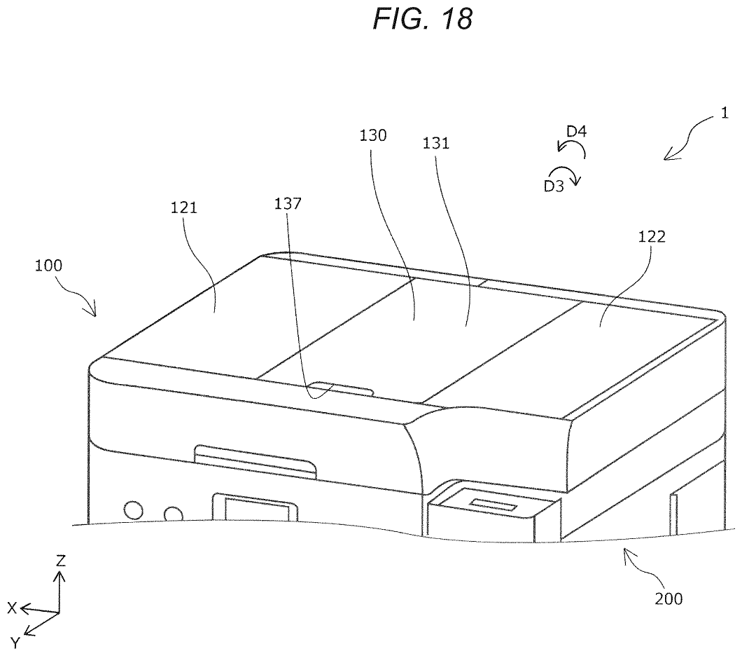

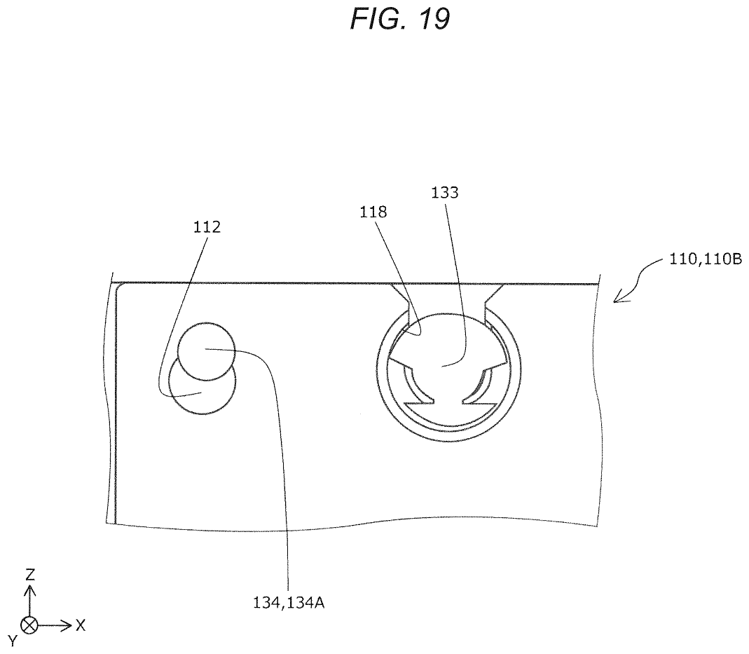

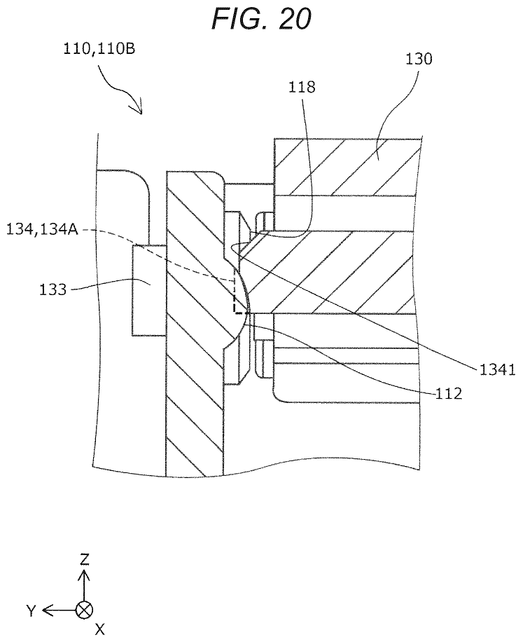

When the cover section 130 changes from the state illustrated in FIG. 15 to a state of being completely closed with respect to the main body section 110 as illustrated in FIG. 18, the lock section 134 is disposed at a position where the lock section 134 is locked by the section to be engaged 112. FIGS. 19 and 20 illustrate a positional relationship between the lock section 134 and the section to be engaged 112 in the state illustrated in FIG. 18. In the state in which the cover section 130 is completely closed with respect to the main body section 110, the lock section 134 is abutted from below by the section to be engaged 112 and the lock section 134 is urged in the upward direction by the section to be engaged 112.

Here, as illustrated in FIGS. 7 and 10, the lock section 134 includes a projection 134A protruding in the Y direction. In the projection 134A, a chamfered region 1341 is formed on the upper side at the time when the cover section 130 is in the closed state with respect to the main body section 110. On the other hand, in the lock section 134, a chamfered region is not formed on the lower side at the time when the cover section 130 is in the closed state with respect to the main body section 110. As illustrated in FIG. 11 and the like, the section to be engaged 112 has a hemispherical shape. With such a configuration, the lock section 134 engages with the section to be engaged 112 with a weak force when the cover section 130 is closed with respect to the main body section 110. When only a weak force is applied to the section to be engaged 112 in a direction of opening the cover section 130 with respect to the main body section 110 in the state in which the cover section 130 is closed with respect to the main body section 110, the cover section 130 does not open with respect to the main body section 110.

In other words, in the reading apparatus 100 in the present embodiment, when the cover section 130 is in the closed state with respect to the main body section 110, the lock section 134 is urged in a direction in which the cover section 130 is in the closed state. With such a configuration, the reading apparatus 100 in the present embodiment can prevent the cover section 130 from rattling when the cover section 130 is in the closed state.

From still another point of view, the lock section 134 includes the projection 134A, the main body section 110 includes the section to be engaged 112, and the projection 134A is chamfered in the region 1341. The section to be engaged 112 engages with the projection 134A when the cover section 130 is closed. The region 1341 is an engagement region that engages with the section to be engaged 112. With such a configuration, the projection 134A serving as the engaging section and the section to be engaged 112 easily engage with each other and it is possible to particularly improve operability in closing and locking the cover section 130.

As illustrated in FIG. 21 and the like, in the cover section 130, the lock sections 134 are provided at both of the end portion on the +Y direction side and the end portion on the −Y direction side in the Y direction corresponding to the axial direction of the turning shaft 133. Therefore, a locked state at the time when the cover section 130 is closed and locked is particularly stable. However, the cover section 130 is not limited to such a configuration. The lock section 134 may be provided only at one end portion of the cover section 130 in the axial direction of the turning shaft 133.

However, the lock section 134 is preferably provided at least at the end portion on the +Y direction side, which is the end portion on one side of the cover section 130 in the axial direction of the turning shaft 133, that is, the end portion on the apparatus front surface side. With such a configuration, since the lock section 134 can be provided on the front surface side of the cover section 130 when viewed from the user, locking can be easily performed by closing the cover section 130 and it is possible to improve operability.

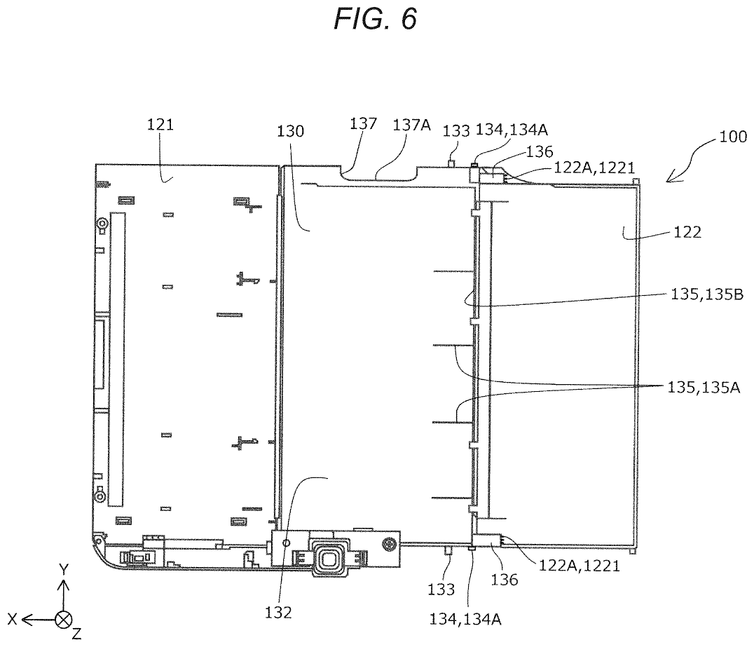

As illustrated in FIGS. 2 and 6, in the reading apparatus 100 in the present embodiment, a plurality of ribs 135 are provided in the cover section 130. Specifically, the cover section 130 includes a plurality of ribs 135A extending in the X direction and a rib 135B extended in the Y direction. The reading apparatus 100 in the present embodiment includes the ribs 135A to reduce a level difference between the cover section 130 and the document support section 117 at the time when a document is supported.

On the other hand, since the cover section 130 includes the rib 135B extending in the Y direction, that is, the axial direction of the turning shaft 133, the cover section 130 can be reinforced. As illustrated in FIG. 6, in the reading apparatus 100 in the present embodiment, the rib 135B is disposed at a position overlapping the axis of the turning shaft 133 when viewed from the Z direction. With such a configuration, it is possible to particularly effectively reinforce the cover section 130.

The turning shaft 133 may be formed of one rod-shaped member extended in the Y direction. By forming the rod-shaped member with metal, it is possible to increase the rigidity of the turning shaft 133. By increasing the rigidity of the turning shaft 133 formed of one rod-shaped member, deformation of the cover section 130 can be suppressed. Since the cover section 130 has the high rigidity, it is possible to suppress twisting and the like of the cover section 130 at the time when a force is applied to the cover section 130 and facilitate locking and unlocking.

Here, the reading apparatus 100 in the present embodiment includes a buffer member 150 on a contact surface 121A of the base frame 121, which is a position that is in contact with the cover section 130 when the cover section 130 is in the closed state. With such a configuration, the reading apparatus 100 in the present embodiment can suppress sound at the time when the cover section 130 is closed and damage involved in closing the cover section 130.

In the reading apparatus 100 in the present embodiment, as illustrated in FIGS. 6 to 9, the cover section 130 includes the arm section 136. The discharge tray 122 serving as the upper surface forming section includes a contact section 122A at a position facing the distal end of the arm section 136 when the cover section 130 is in the closed state. Since the contact section 122A is pressed from the lower side to the upper side by the arm section 136 when the cover section 130 is in the closed state, the discharge tray 122 is substantially in the horizontal direction as illustrated in FIG. 4. When the cover section 130 opens and the contact section 122A moves to a position where the contact section 122A does not face the arm section 136, the discharge tray 122 is disposed to be inclined when viewed from the Y direction as illustrated in FIG. 5.

The contact section 122A includes a rib 1221 extending in the Y direction corresponding to an intersecting direction intersecting the axial direction of the turning shaft 133. With such a configuration, in the reading apparatus 100 in the present embodiment, the contact section 122A is reinforced. Further, by providing the rib 1221 as in the present embodiment, it is also possible to improve a sliding property between the arm section 136 and the contact section 122A at the time when the cover section 130 is opened and closed.

In the reading apparatus 100 in the present embodiment, as illustrated in FIGS. 6 and 21 and the like, the operation section 137 is provided at the end portion on one side (the +Y direction side) of the cover section 130 in the axial direction of the turning shaft 133. That is, in the reading apparatus 100 in the present embodiment, the operation section 137 is provided on the front surface side of the cover section 130 when viewed from the user. Therefore, the reading apparatus 100 in the present embodiment can particularly improve operability in opening and closing the cover section 130.

Here, as illustrated in FIGS. 6 and 21 and the like, the operation section 137 includes the grip section 137A that can be gripped by the user. The grip section 137A is located further on the other side (the −Y direction side) in the axial direction of the turning shaft 133 than the lock section 134. With such a configuration, the reading apparatus 100 has, as a power point, a position close to the center in the axial direction (the Y direction) of the turning shaft 133. Accordingly, for example, a force is easily transmitted to both of the lock section 134 on the +Y direction side and the lock section 134 on the −Y direction side and operability in opening and closing the cover section 130 is particularly improved. Further, with such a configuration, it is possible to prevent the grip section 137A from protruding to the outer side in the Y direction and it is possible to prevent the apparatus from increasing in size.

The grip section 137A is provided at a position including the center in the X direction of the cover section 130. With such a configuration, the user can easily access the grip section 137A and the reading apparatus 100 in the present embodiment can particularly improve operability in opening and closing the cover section 130. With such a configuration, it is also possible to suppress deformation of the cover section 130. However, the position, the size, the shape, and the like of the operation section 137 in the cover section 130 are not particularly limited.

### Second Embodiment

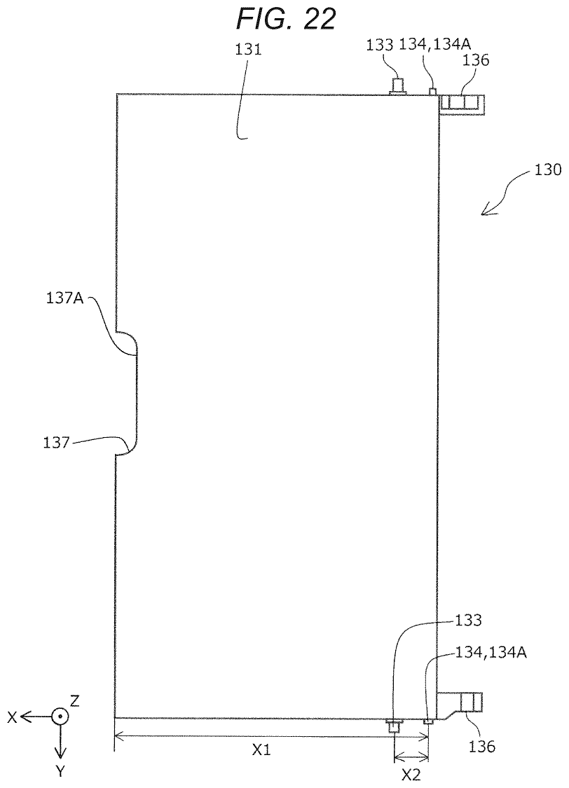

Subsequently, the reading apparatus 100 in a second embodiment is explained with reference to FIG. 22. In FIG. 22, constituent members common to the first embodiment explained above are denoted by the same reference numerals and signs and detailed explanation of the constituent members is omitted. FIG. 22 is a diagram corresponding to FIG. 21 in the reading apparatus 100 in the first embodiment. Here, the reading apparatus 100 in the present embodiment has the same configuration as the reading apparatus 100 in the first embodiment except for a configuration of the cover section 130. For this reason, concerning portions other than portions explained below, the reading apparatus 100 in the present embodiment has the same characteristics as the characteristics in the reading apparatus 100 in the first embodiment.

As illustrated in FIG. 22, in the cover section 130 of the reading apparatus 100 in the present embodiment, the operation section 137 is provided at the end portion on the +X direction side of the cover section 130. However, like the cover section 130 in the reading apparatus 100 in the first embodiment, in the X direction, the distance X1 from the operation section 137 to the lock section 134 is longer than the distance X2 from the turning shaft 133 to the lock section 134. The X direction is an intersecting direction intersecting the Y direction that is the axial direction of the turning shaft 133. Even with such a configuration, as in the reading apparatus 100 in the first embodiment, it is possible to improve operability of a user in opening and closing the cover section 130.

Note that the present disclosure is not limited to the embodiment explained above. Various modifications are possible within the scope of the disclosure described in the claims. It is needless to say that the modifications are also included in the scope of the present disclosure.

What is claimed is:

1. A reading apparatus comprising:
a main body section in which a reading section configured to read a document is provided;
a document support section configured to support the document before being fed;
a feeding section configured to feed the document supported by the document support section toward the reading section;
a cover section capable of opening and closing by turning with respect to the main body section, a first surface of the cover section forming an upper surface in a closed state and a second surface of the cover section opposite to the first surface forming a support surface that supports the document in conjunction with the document support section in an open state; and
an upper surface forming section forming an upper surface in conjunction with the cover section, wherein
the cover section includes:
an operation section serving as a power point in opening and closing;
a turning shaft serving as a fulcrum in opening and closing; and
a lock section restricted from being opened in the closed state, and a distance from the operation section to the lock section is longer than a distance from the turning shaft to the lock section in an intersecting direction intersecting an axial direction of the turning shaft.

2. The reading apparatus according to claim 1, wherein the lock section is urged in a direction in which the cover section is closed.

3. The reading apparatus according to claim 1, wherein the operation section is provided at an end portion on one side in the axial direction of the cover section.

4. The reading apparatus according to claim 1, wherein the lock section is provided at an end portion on one side in the axial direction of the cover section.

5. The reading apparatus according to claim 1, wherein
the operation section and the lock section are provided at an end portion on one side in the axial direction of the cover section,
the operation section includes a grip section, and
the grip section is located further on another side in the axial direction than the lock section.

6. The reading apparatus according to claim 1, wherein
the operation section and the lock section are provided at an end portion on one side in the axial direction of the cover section,
the operation section includes a grip section, and
the grip section is provided at a position including a center in the intersecting direction of the cover section.

7. The reading apparatus according to claim 1, wherein
the lock section includes a projection,
the main body section includes a section to be engaged with which the projection engages when the cover section is in the closed state, and
in the projection, an engagement region that engages with the section to be engaged is chamfered.

8. The reading apparatus according to claim 1, wherein the cover section includes a rib extended in the axial direction.

9. The reading apparatus according to claim 1, further comprising a buffer member that comes into contact with the cover section when the cover section is in the closed state.

10. The reading apparatus according to claim 1, wherein
the cover section includes an arm section,
the upper surface forming section includes a contact section at a position facing a distal end of the arm section when the cover section is in the closed state, and
the contact section includes a rib extended in the intersecting direction.
